(19) United States
(12) Patent Application Publication
(10) Pub. No.: US 2026/0021790 A1
(43) Pub. Date: Jan. 22, 2026

(54) Windshield Cleaning Appliance and Cleaner Composition

(71) Applicants: Dennis Willard Davis, Palm Bay, FL (US); James Grant Wallin, Terra Ceia, FL (US); Alice McKinstry Davis, Palm Bay, FL (US)

(72) Inventors: Dennis Willard Davis, Palm Bay, FL (US); James Grant Wallin, Terra Ceia, FL (US); Alice McKinstry Davis, Palm Bay, FL (US)

(21) Appl. No.: 19/342,616

(22) Filed: Sep. 28, 2025

Related U.S. Application Data
(63) Continuation-in-part of application No. 17/751,881, filed on May 24, 2022.
(63) Continuation-in-part of application No. 16/872,682, filed on May 12, 2020, now abandoned.
(60) Provisional application No. 62/920,738, filed on May 13, 2019.
(60) Provisional application No. 63/194,256, filed on May 28, 2021.
(60) Provisional application No. 63/825,481, filed on Jun. 17, 2025.
(60) Provisional application No. 63/863,901, filed on Aug. 14, 2025.

(51) Int. Cl. B60S 1/04; C11D 17/00; C11D 17/04

(52) U.S. Cl. CPC B60S 1/0491; C11D 17/0039; C11D 17/049

(57) ABSTRACT

Presently disclosed are embodiments of devices for expedient removal of insect and other debris from vehicle surfaces including windshields. A surfactant-based chemical impregnation of porous material is central to various tools used for such cleaning. Embodiments include a wiper attachment and tools for dispensing disposable chemically-impregnated pads. A disposable windshield wiper blade attachment that incorporates chemicals that will expedite insect and other debris removal when attached to the wiper blades and the wiper action is performed. The attachment can take the form of fabric, foam, or other porous enclosure of synthetic or natural material that is impregnated with chemicals or pressure-sensitive micro-encapsulated surfactant formulations that will facilitate rapid removal of the windshield and automobile surface debris.

### CROSS-REFERENCE TO RELATED APPLICATIONS

This application is a continuation-in-part of U.S. patent Ser. No. 17/751,881 filed May 24, 2022 which is a continuation-in-part of U.S. patent Ser. No. 16/872,682 filed May 12, 2020 and claims the benefit of provisional application Patent application Ser. No. 63/863,901 filed Aug. 14, 2025, provisional application Patent application Ser. No. 63/825,481 filed Jun. 17, 2025, U.S. provisional application Patent Application Ser. No. 63/194,256 filed May 28, 2021, and U.S. provisional application Patent Application Ser. No. 62/920,738 filed May 13, 2019.

### BACKGROUND

Motorized vehicles of all kinds, including cars, trucks, recreational vehicles, heavy equipment vehicles, buses, boats, and private aircraft, are invariably impacted by insects colliding with the vehicle windshield. The resulting insect residue on windshields can be messy and especially difficult to remove if the insect debris has become desiccated.

The windshields, grills, bumpers, and other surfaces of moving vehicles encounter many different species of insects, but larger numbers are associated with particular ones including mayflies of the northern US, midges or small flies (including aquatic midges known as blind mosquitos and no-see-ums) and mosquitoes found throughout the US. Particularly bothersome is the love bug (Plecia nearctica), a species of March fly found in the southeastern United States, especially along the Gulf Coast.

Often, the insect debris is of sufficient volume that the windshield and wiper blades need to be toweled in addition to using wiper motion with dispensed wiper fluid. Quite often, wipers will simply smear the insect debris across the windshield. In the event the wiper fluid is depleted, things are even more difficult. When remote from a gas station there is the inconvenience of the need to locate a source of water for cleaning the windshield. A particular challenge is the removal of desiccated insect debris that adheres tenaciously to vehicle surfaces including glass windshields. Methyl alcohol (the chief ingredient of wiper fluid) alone, often is ineffective in removing desiccated insect and other debris from windshields.

### PRIOR ART

To date, methods to address difficult-to-remove windshield dirt comprise use of windshield wiper fluid, dispensed while operating windshield wipers (this often smears the dirt deposits), and Ice scrapers and squeegees, which usually must be used in concert with paper towels or rags.

U.S. patent application number 2004/0156991 to Brown et al. discloses a dispenser that is attached to or made part of a wiper blade that dispenses hydrophobic or hydrophilic surface treatment material to the windshield for either repelling water or wetting the windshield, respectively. This involves a modification of the actual wiper blade that could accumulate debris.

The product called Scrubberblade (https://gadgetsgo.com/scrubbing-wind-shield-wipers.html) comprises a wiper double blade design that exhibits small protuberances on the blades. Even this improved wiper blade design will have trouble with desiccated debris.

U.S. Pat. No. 6,687,946 discloses a wiper blade attachment with pressurized inflatable scrubbing member. The device is pressurized by windshield wiper fluid and permits seepage of fluid onto the windshield. This is a semi-permanent attachment and is not disposable.

U.S. patent application No. 20130000802 provides an example of coverings for windshield wiper blades designed to impede ice formation on the blades. Other such covers are for the purpose of preventing ultraviolet light damage to the blade rubber.

U.S. Pat. No. 7,386,910 discloses a cleaning pad that is button-detachable from a handle for toilet bowl cleaning.

It would be advantageous to have a system of appliances and tools based on effective insect debris removal chemistry that can be used to clean external vehicle surfaces of these contaminants. More particularly, an approach that uses windshield wipers for efficient insect debris removal should be sought that a) does not involve modification of the wiper blade, i.e. adhoc modification of the existing wiper or replacement with blades of a different design, b) minimizes the user's exposure to the dirt and debris to be removed, and c) is disposable. Additionally, the chemistry used for the aforementioned mechanism would be useful for hand wipes, windshield wiper fluid, and manual tools that dispense this chemistry for insect debris removal from vehicle surfaces.

### SUMMARY OF THE INVENTION

Presently disclosed is a set of embodiments that each exploit chemical means of removing insect debris from vehicle bodies, bumpers and windshields. Chemically-impregnated material is part of various embodiments disclosed. Among the disclosed embodiments are a disposable windshield wiper blade attachment that incorporates chemicals that will expedite insect and other debris removal when attached to the wiper blades and the wiper action is performed. The attachment can take the form of fabric, foam, or other porous enclosure of synthetic or natural material that is impregnated with chemicals that will facilitate rapid removal of the windshield debris. Other embodiments include a handheld tool with pad or roller dispensers of chemically-impregnated porous material. Variants of such tools include a squeegee. Additionally, chemically-impregnated material affixed to hand mitts and formulations of windshield wiper fluid containing chemistries effective for insect debris removal are disclosed.

The following definitions serve to clarify the disclosed and claimed invention:

Surfactants—are compounds that lower the surface tension (or interfacial tension) between two liquids, between a gas and a liquid, or between a liquid and a solid. Surfactants may act as detergents, wetting agents, emulsifiers, foaming agents, or dispersants. Surfactants are usually organic compounds that are amphiphilic, meaning they contain both hydrophobic groups (their tails) and hydrophilic groups. Therefore, a surfactant contains both a water-insoluble (or oil-soluble) component and a water-soluble component. Surfactants will diffuse in water and adsorb at interfaces between air and water or at the interface between oil and water, in the case where water is mixed with oil. The water-insoluble hydrophobic group may extend out of the bulk water phase, into the air or into the oil phase, while the water-soluble head group remains in the water phase.

Backer—for an embodiment that employs a handle and a releasably attachable cleaning pad this refers to a relatively stiff, largely planar component to which the pad is attached by adhesive or other bonding approach.

Fatty acid—is a carboxylic acid with a long aliphatic chain, which is either saturated or unsaturated.

Glyceride—is a fatty acid ester of glycerol.

Impregnated material—refers to porous material that is chemically-impregnated with insect debris cleaning compounds such as surfactants or surfactant polymers.

Knob or protrusion—is an appendage on the face of the backer opposing the pad face. It can be releasably captivated by a mechanism in the handle such as a flexible collet and can be integral to the backer or a separate part adhered to the backer.

Microencapsulants—refers to surfactant formulations enclosed in capsules measuring typically tens of microns in diameter that can be made to burst open with predetermined levels of pressure. These microencapsulants can coat the surface of dispensing material such as a fabric or polymer or can impregnate a porous dispensing material. The bursting pressure is a result of user manual force transmitted by means of an attached handle to the microencapsulants.

Microfiber—is synthetic fiber finer than one denier or decitex/thread, having a diameter of less than ten micrometers. The most common types of microfiber are made variously of polyesters; polyamides; and combinations of polyester, polyamide, and polypropylene.

Polyquaterniums (polyquats)—are a variety of engineered polymer forms which provide multiple quat molecules within a larger molecule.

Quats (quaternary ammonium compounds)—are positively charged polyatomic ions of the structure NR₄⁺ with R being alkyl or aryl groups. The R groups may also be connected.

Rigid handle—refers to a non-telescoping handle.

Substrate—refers to the cleaning pad and cleaning pad composition for an embodiment that employs a handle and a releasably attachable pad. The substrate is attached to a backer that exhibits a protrusion that is captivated by a mechanism in the handle.

### DESCRIPTION OF THE DRAWINGS

FIG. 1 is a pictorial diagram of a windshield wiper blade assembly and arm.

FIG. 2A is a pictorial diagram of a windshield wiper blade assembly and arm highlighting the angle between the arm and the blade assembly.

FIG. 2B is a pictorial diagram of a windshield cleaning wiper attachment that exhibits clamping tension and a slot for installation and removal.

FIG. 2C is a pictorial diagram of the windshield cleaning wiper attachment of FIG. 2B installed on a windshield wiper blade assembly.

FIG. 3A is a pictorial diagram of a windshield cleaning wiper attachment that is attached to the wiper assembly by tabs.

FIG. 3B is a pictorial diagram of a windshield cleaning wiper attachment that is attached to the wiper assembly by affixing strips.

FIG. 4A is a pictorial diagram of a windshield cleaning wiper attachment that comprises a bag geometry enclosing the windshield wiper blade assembly and a portion of the arm . . .

FIG. 4B is a pictorial diagram of a windshield cleaning wiper attachment that comprises a bag geometry enclosing the windshield wiper blade assembly the exhibits a pleated region in the area of the arm attachment to the wiper blade assembly.

FIG. 4C is a pictorial diagram of a windshield cleaning wiper attachment that comprises a dual bag geometry with one bag end overlapping and closing upon the other bag end.

FIG. 5A is a pictorial diagram of a windshield wiper blade assembly and arm characteristic of trucks and other vehicles in which the angle between the arm and the blade assembly remains relatively constant.

FIG. 5B is a pictorial diagram of a windshield cleaning wiper attachment adapted to the windshield wiper blade assembly and arm of FIG. 5A comprising and enclosure of both the windshield wiper blade assembly and a portion of the arm.

FIG. 6A is a pictorial diagram of a cleaning tool that has a roller dispenser of chemically-impregnated cleaning material.

FIG. 6B is a pictorial diagram of a roller locking mechanism for the tool of FIG. 6A.

FIG. 7 is a pictorial diagram of a tool having the dispenser of FIG. 6A, but including a squeegee.

FIG. 8 is a pictorial diagram of a cleaning tool that exhibits a dispenser of peelable cleaning wipes.

FIG. 9 is a pictorial diagram of a cleaning tool the exhibits a roller dispenser for peelable cleaning wipes.

FIG. 10A is a pictorial diagram of a shaped mitt with an attached chemically-impregnated material for cleaning.

FIG. 10B is a pictorial diagram of a relatively unshaped mitt with an attached chemically-impregnated material for cleaning . . . .

FIG. 11A is a pictorial diagram of a wiper sleeve that employs the box as a dispensing means.

FIG. 11B is a pictorial diagram of a wiper sleeve that employs the box as a disposal means.

FIG. 12 is a pictorial diagram of a wiper sleeve assembly exhibiting an inner and outer sleeve.

FIG. 13 is a pictorial diagram of a single layer wiper sleeve.

FIG. 14 is a pictorial diagram of a wiper sleeve exhibiting a gathered portion for inverting the sleeve for removal from the wiper blade assembly.

FIG. 15 is a pictorial diagram of sleeve folding geometries.

FIG. 16 is a pictorial diagram of an invertible sleeve folding geometry applied to a wiper blade assembly.

FIG. 17 is a schematic diagram of a prior art cleaning pad detachment mechanism.

FIG. 18 is a pictorial diagram of a telescoping handle device with a push button detachable cleaning pad.

FIG. 19 is a functional diagram of a pad detachment mechanism for use in a telescoping handle.

FIG. 20 is a pictorial diagram of a multilayer polymer film windshield tear-off.

FIG. 21 is a pictorial diagram of a segmented multilayer polymer film windshield tear-off.

### DETAILED DESCRIPTION OF THE INVENTION

A disposable sleeve or enclosure for removable application to windshield wipers that contains chemicals that expedite the removal of dried material from windshields such as insect debris, especially dried insect debris is disclosed below.

### Debris Removal Chemistry

The central objective of a cleaning compound in the context of the present invention is to overcome desiccation because to remove the insect residue, forces have to be brought to bear at the interface between the insect debris and the automobile surface. Application of water and cloth friction will do nothing because the dry insect is, effectively, an extension of the automobile. While it's easy to remove a large dried volume of insect residue by applying leverage to peel it off, there are no peeling forces in the case of a thin desiccated material layer. However, once the insect debris is swollen, the wiping of a cloth applies forces adequate for removal; a few molecules of water between two surfaces drastically decrease adhesion. Hence, compounds that can hydrate the insect debris, dissolve the protein content, and emulsify contained fats and oils form the basis of cleaning formulations in the present invention.

Consequently, there are a number of chemical compounds and mixtures that can be used in the present invention and are within the scope of this disclosure. Among them are methyl alcohol, petroleum distillates, ethylene glycol mono butyl ether, other degreasers, fatty acids, and glycerides, Mr. Clean Magic Eraser, WD-40, and Avon Skin-So-Soft. Additionally, it has been found that dampened laundry dryer sheets are exceedingly efficient at removing dried insect debris from automobiles without the need for scrubbing. Formulations for dispensing cleaner as a windshield wiper fluid and for impregnation into cleaning papers or cloths are disclosed herein. The latter formulations for paper or cloth can be dispensed by means of disposable windshield wiper appliances and cleaning tools of various forms as discussed below.

In addition to efficiency of insect debris removal, other important properties of a useful chemistry for this application include ease of formulation, absence of human and animal toxicity, biodegradability, ease of use, and economical implementation. Commercial laundry softeners and hair softeners and conditioners contain compounds that are ideal candidates for cleaning formulations in the present invention and exhibit many if not all of these properties.

Specifically, the fabric conditioning agents within dryer sheets that are transferred to laundry to impart fabric softening or other conditioning features exhibit surfactant properties useful in the present invention. For the purposes of the present invention, other chemicals found in dryer sheets that have been identified as potential carcinogens, hazardous pollutants, or endocrine disruptors are unnecessary. Among the typical softening agents found in dryer sheets are quaternary ammonium compounds (quats), glycerides, and fatty acids. Detail concerning compounds impregnated in dryer sheers is disclosed in U.S. Pat. No. 7,943,566 to Uitenbroek et al. and U.S. Pat. No. 5,080,810A to Smith et al, which disclose methods of manufacturing dryer sheets and are incorporated herein by reference thereto. Among such agents including surfactants found in dryer sheets, are silicone oils or tallow or vegetable-based quaternary ammonium compounds, these include alkylated quaternary ammonium compounds, ring or cyclic quaternary ammonium compounds, aromatic quaternary ammonium compounds, diquaternary ammonium compounds, amidoamine quaternary ammonium compounds, ester quaternary ammonium compounds, and mixtures of these.

Specific examples of these candidate compounds include monoesterquats, diesterquats, triesterquats, and mixtures thereof. These monoesterquats and diesterquats are selected from the group consisting of bis-(2-hydroxypropyl)-dimethylammonium methylsulfate fatty acid ester and isomers of bis-(2-hydroxypropyl)-dimethylammonium methylsulfate fatty acid ester and/or mixtures thereof, 1,2-di(acyloxy)-3-trimethylammoniopropane chloride, N,N-bis(stearoyl-oxy-ethyl)-N,N-dimethyl ammonium chloride, N,N-bis(tallowoyl-oxy-ethyl) N,N-dimethyl ammonium chloride, N,N-bis(stearoyl-oxy-ethyl)-N-(2 hydroxyethyl)-N-methyl ammonium methylsulfate, N,N-bis-(stearoyl-2-hydroxypropyl)-N,N-dimethylammonium methylsulfate, N,N-bis-(tallowoyl-2-hydroxypropyl)-N,N-dimethylammonium methylsulfate, N,N-bis-(palmitoyl-2-hydroxypropyl)-N,N-dimethylammonium methylsulfate, N,N-bis-(stearoyl-2-hydroxypropyl)-N,N-dimethylammonium chloride, 1,2-di-(stearoyl-oxy)-3-trimethyl ammoniumpropane chloride, dicanoladimethylammonium chloride, di(hard) tallowdimethylammonium chloride, dicanoladimethylammonium methylsulfate, 1-methyl-1-stearoylamidoethyl-2-stearoylimidazolinium methylsulfate, 1-tallowylamidoethyl-2-tallowylimidazoline, dipalmylmethyl hydroxyethylammoinum methylsulfate and mixtures thereof.

The categories of surfactants delineated in UK patent application number GB2185752A are hereby incorporated by reference thereto. These and other compounds that can promote efficient removal of insect and other debris from windshields are within the scope of the present invention.

Quats comprise some of the most potent surfactants that will lift and emulsify oil and fat residues of desiccated insects on vehicle glass, chromed bumpers, and painted bodies. A good survey of quat chemistry is provided by Bures (F. Bures, “Quaternary Ammonium Compounds: Simple in Structure, Complex in Application,” Topics in Current Chemistry (2019) 377:14). Many insects have a chitin- and protein-rich exoskeleton, and they are filled with an acidic liquid called hemolymph that is rich in digestive enzymes. This combination makes dead insects stick extremely well to vehicle surfaces. Hence, attention should be paid to controlling cleaner pH levels to augment debris removal without harming vehicle finishes. Quats such as benzalkonium chloride, used as medical disinfectants because they can denature cell proteins, can facilitate removal of proteinaceous insect debris. Examples of biodegradable quats include: a mixture of octyl decyl dimethyl ammonium chloride, dodecyl dimethyl ammonium chloride, and dioctyl dimethyl ammonium chloride, alkyl (C₁₄, 50%; C₁₂, 40%; C₁₆, 10%) dimethyl benzyl ammonium chloride, as well as the compounds disclosed in European Patent Number EP0239910A2. Additionally, efforts have been underway for some time to design environmentally friendly quats (T. Thorsteinsson et al, “Soft Antimicrobial Agents: Synthesis and Activity of Labile Environmentally Friendly Long Chain Quaternary Ammonium Compounds,” J. Med. Chem. 2003, 46, 19, pp. 4173-4181.) that exhibit potential for cleaning effectiveness in the present invention.

Cationic surfactants are the magic behind hair conditioners because they latch strongly onto the negative charges on damaged hair. The right conditioners also attract moisture to eliminate static. These properties can be used to “condition” the insect debris for its removal from hard surfaces. In the hair care industry, considerable progress has been made in creating cationic polymers from natural substances, to facilitate biodegradability. The introduction of longer chain alkylquat groups onto the polymer substrate produces a family of products having distinct physical and conditioning properties. Here, the effect of a cationic substrate is combined with functional properties normally associated with fatty acid quats like hair manageability, lubricity, anti-static properties, surface activity and biocidal activity (H. Feigenbaum et al., “The Use of Cationizing Reagents in the Preparation of Conditioning Polymers for Hair and Skin Care,” SKW QUAB Chemicals, Incorporated, Saddle Brook, New Jersey.) Among the class of cationic polymers are polyquaternium compounds that are used in vast quantities in hair conditioners. These compounds can penetrate hard-to-access interfaces on automobile surfaces and will attract water to do the one thing most required to facilitate insect removal which is rehydration of the insect debris. Insects' cells are surrounded by negatively charged lipids so again the polyquaternium compounds can attach to them—with the rest of the cationic chain attracting water. With the presence of the water, the cationic compound will dissolve the cell walls and the water soluble interior will also swell. The behavior of many polyquaternium compounds is insensitive to solution pH and water hardness which is conducive to their use in the present application. An example of a biodegradable compound of this type is the polyquaternium dermofeel® quadegra produced by Dr. Straetmans GmbH, Hamburg, Germany.

Cleaning formulations comprising aqueous- or alcohol-based solutions of surfactants or other active ingredients will typically involve concentrations of only a few volume percent of these ingredients.

### Embodiments

Various embodiments of the present invention are herein disclosed that exploit chemistries useful for insect debris removal from windshields, bumpers and vehicle bodies. The taxonomy of embodiments comprises a) chemically-impregnated material removably attachable to wiper blades or blade assemblies, b) a roller dispenser of chemically-impregnated material, c) a combination of squeegee and roller dispenser of chemically-impregnated material, d) a pad dispenser of chemically-impregnated material, e) squeegee and pad dispenser combination, e) wipes of chemically-impregnated material, f) mitts with attached pads that are chemically-impregnated, g) push button detachable pads, h) telescoping handles, and i) multilayer polymeric windshield films. The use of pressure sensitive microencapsulated surfactant formulations also is disclosed.

With respect to variants of the invention embodiment for wipers, all are a form of chemically-impregnated material removably attachable to windshield wiper blades or blade assemblies. The wide variety of feasible shapes for the removably attachable device is within the scope of the presently disclosed concept. Accommodation must be made for the variation in wiper blade sizes from vehicle to vehicle and, as described below, for embodiments that work with dynamic changes in wiper blade assembly geometry. These embodiments emphasize avoidance of hand contact with dirt, ease of application, and ease of disposal. The material to be chemically-impregnated is preferably microporous in nature. The most potent cleaning force is physical abrasion due to the no slip boundary condition (the cleaning fluid has zero velocity at the surface) between the insect debris and the automobile surface. Hence, this explains the improved cleaning performance of microfiber cloths which have far more surface contact than normal cloths and thereby translate more applied force into actual cleaning force.

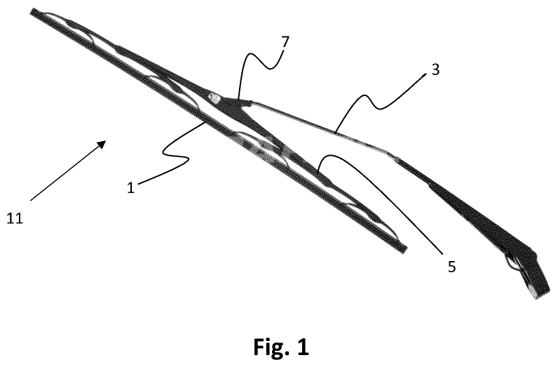

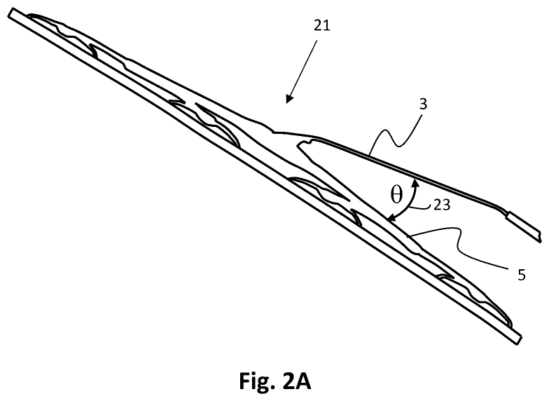

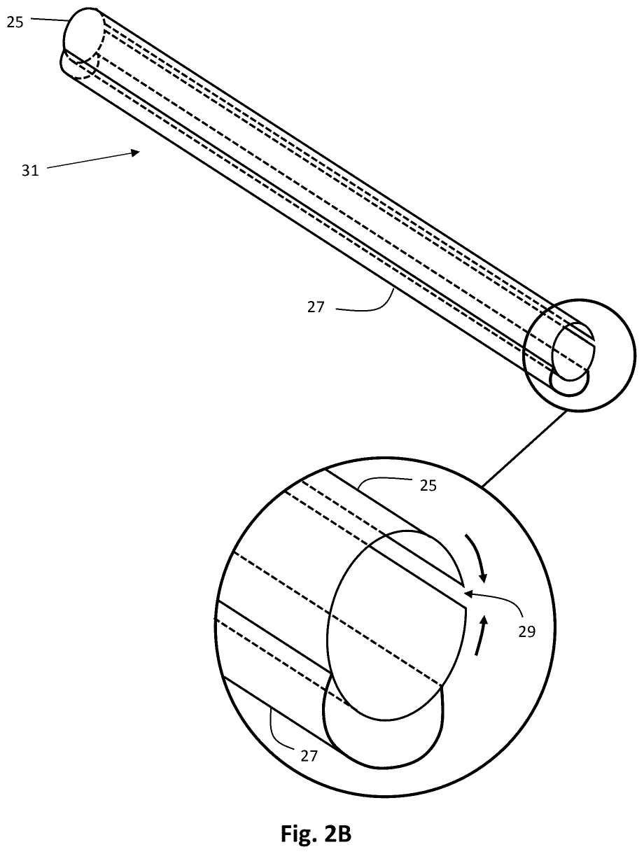

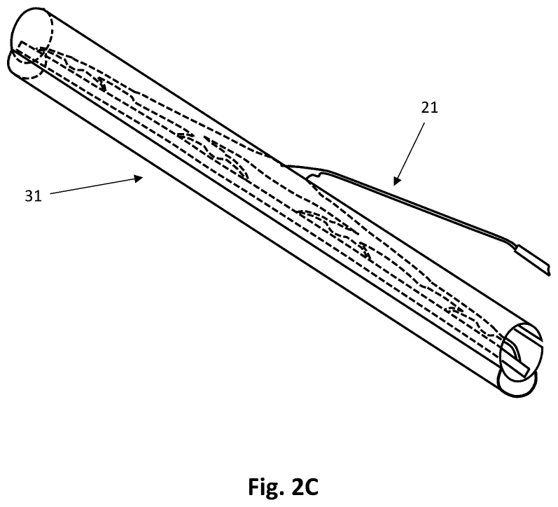

Reference is made to FIG. 1 which depicts the basic geometry 11 of the typical automobile windshield wiper system. The wiper blade 1 is held by the wiper blade assembly 5 that is mounted to the wiper arm 3 by articulating connection 7. FIG. 2A emphasizes the variation in angle 23 that can occur between the arm 3 and the wiper assembly 5 during wiper motion. For selected embodiments of the presently disclosed concept, angle variation must be accommodated. FIG. 2B depicts a first embodiment of a windshield cleaning attachment 31 comprising a stiff, but not rigid, cylinder 25 that exhibits a longitudinal slot 29. The cylinder 25 is constructed from a plastic or other material that demonstrates adequate closure tension for mounting on the wiper blade assembly. The slot edges of the cylinder are spread apart for installation on the wiper blade assembly. Attached to the stiff cylinder 25 is a pliable chemical containing pad 27 that is located at a circumferential position along the length of the cylinder that permits it to make contact with the windshield after it is installed on the wiper blade assembly as shown in FIG. 2C. Various cleaning chemicals previously discussed are candidates for impregnation of the pad 27. The cylinder 25 can be made of plastic, laminated card stock, or other semi rigid material that can be made to provide closure tension. The pad 27 can be made from natural or synthetic fabric, foam, or other porous material with volume enough to contain adequate cleaning chemical.

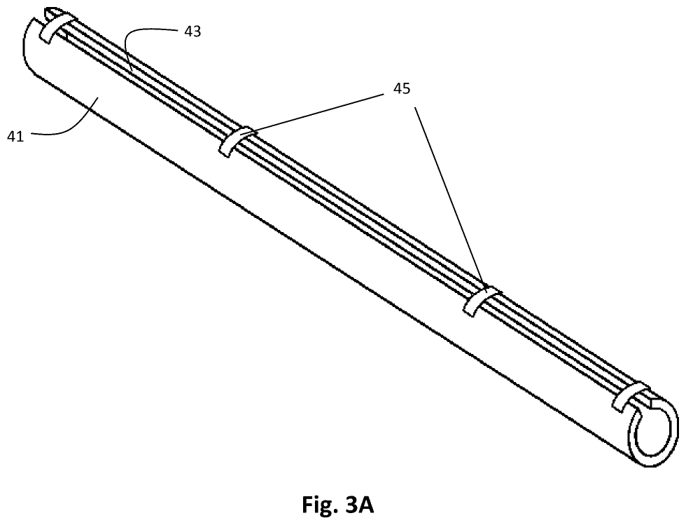

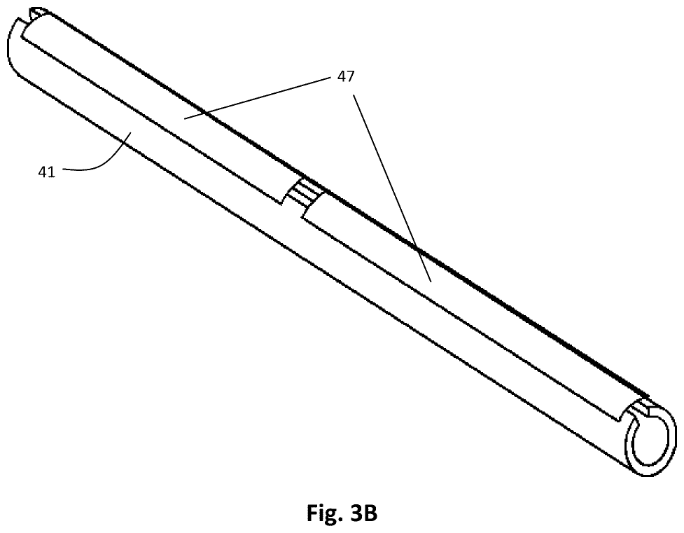

FIG. 3A depicts a cleaning chemical impregnated pad 41 that when mounted on the wiper blade assembly encloses it and demonstrates closure tabs 45 across the opening 43 created by the pad edges. The tabs can be Velcro™ or adhesive-based fasteners. In FIG. 3B, closure strips 47 are shown substituted for tabs. Alternatively, the pad need not enclose the wiper blade assembly, but simply attach to the region of the blade that makes windshield contact.

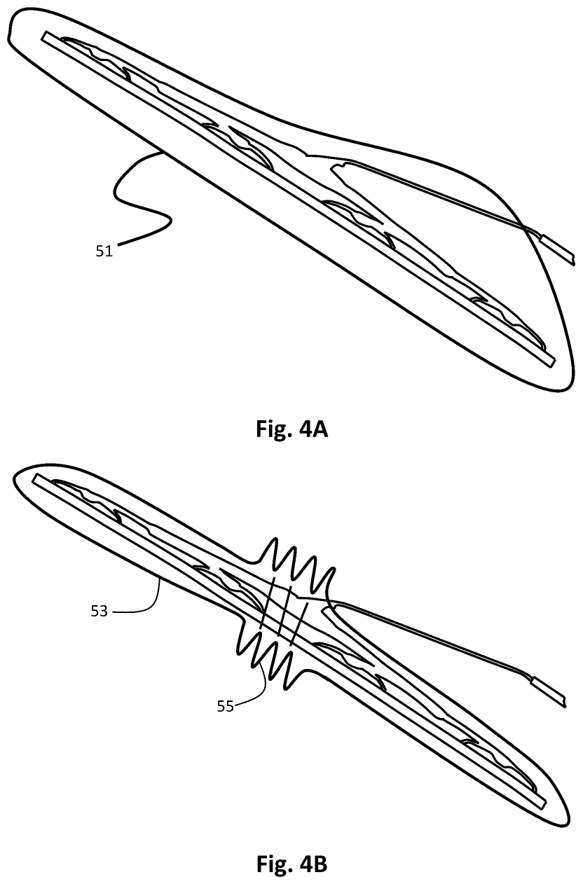

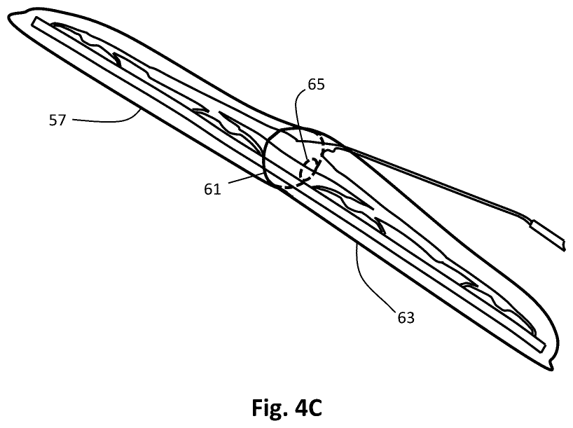

Bag geometries of the invention are shown in FIGS. 4A, B, and C. FIG. 4A depicts a bag or sleeve that encloses both wiper blade assembly and arm and accommodates the change in angle between the wiper blade assembly and the arm. The bag or sleeve is impregnated with cleaning chemical and may contain a pouch volume, not shown, for sufficient dispensing of chemical. FIG. 4B depicts a bag geometry that has a pleated region 53 to accommodate wiper changes in geometry during motion. The bag can have a closure mechanism, not shown, such as a draw string, Velcro™ strip, or elastic closure. Alternatively, the bag itself can exhibit elasticity sufficient to remain affixed to the wiper assembly during wiper motion. Yet another prospect is for the bag or sleeve to be slide onto the wiper assembly and have a tear away feature for ease of removal. A dual bag geometry is shown in FIG. 4C. A first bag 57 is used to cover a portion of the wiper blade assembly and had a cinched closure 65 at one end. A second bag 63 encloses the balance of the wiper blade assembly, overlaps the first bag 57 and has a cinched closure 61 atop the first bag. Bags 57 and 61 both have a chemical dispensing volume, not shown, in contact with the windshield.

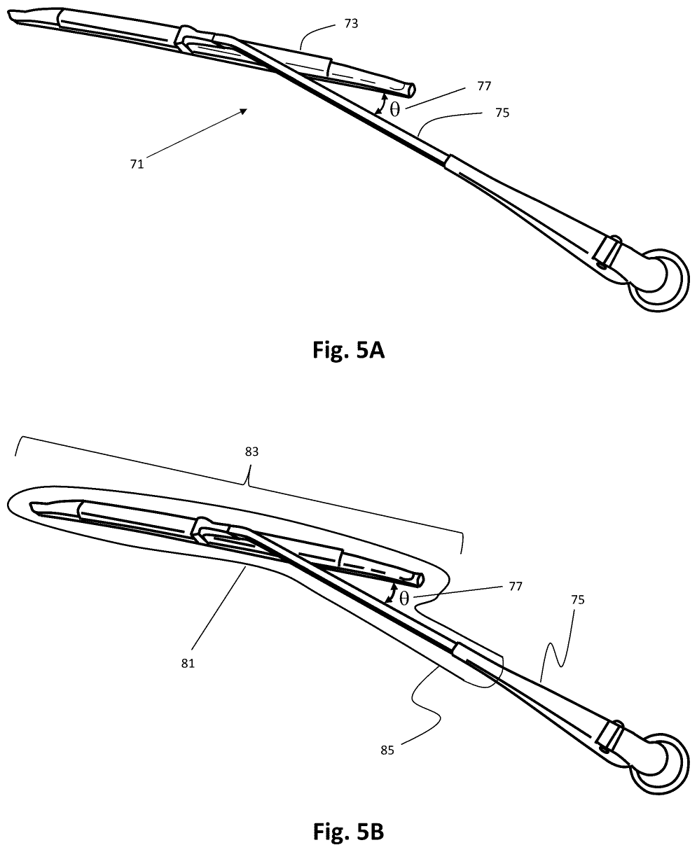

FIG. 5A depicts a wiper geometry 71 often found on trucks and other vehicles in which the angle 77 is relatively constant during wiper motion. In FIG. 5B, the bag 81 used in this instance encloses the region 83 of the wiper and region 85 of the wiper arm.

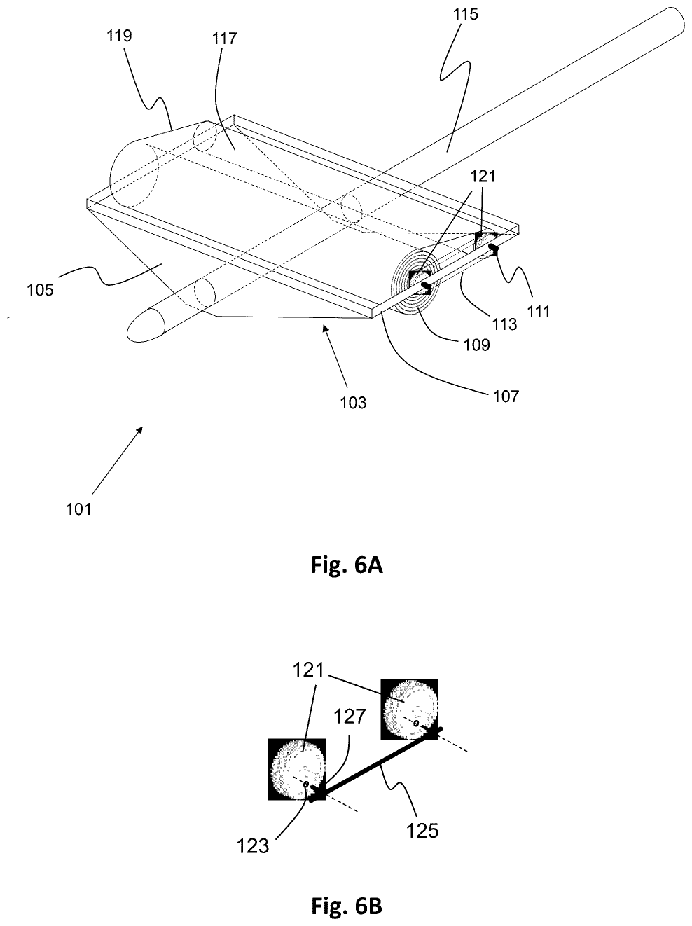

A cleaning appliance 101 exhibiting a roller dispenser 103 is depicted in FIG. 6A. Dispensing roller 109 feeds impregnated fabric (cloth, paper, etc.) to take-up roller 117. The area of the impregnated material that contacts a surface to be cleaned is maintained in tension by means of the gears 121 attached to the respective rollers 109 and 117 that are synchronized by roller belt 113. The axles 111 of the rollers are captivated in the frame 107 which is attached to the handle 115 by means of plates 105. The combination of the dispenser roller 109 and take-up roller 117 can be provided as a cartridge type consumer item wherein the rollers are in fixed relative disposition for sliding onto roller axles of the appliance 101, not shown.

FIG. 6B depicts a locking mechanism actuated by push button means, well known in the prior art and not shown. A bar 125 connects two locking pins 127 that are removably insertable into respective receptacles 123 in each of the gears 121. The pins 127 would be inserted to maintain the impregnated material stationary in the appliance 101 during surface cleaning.

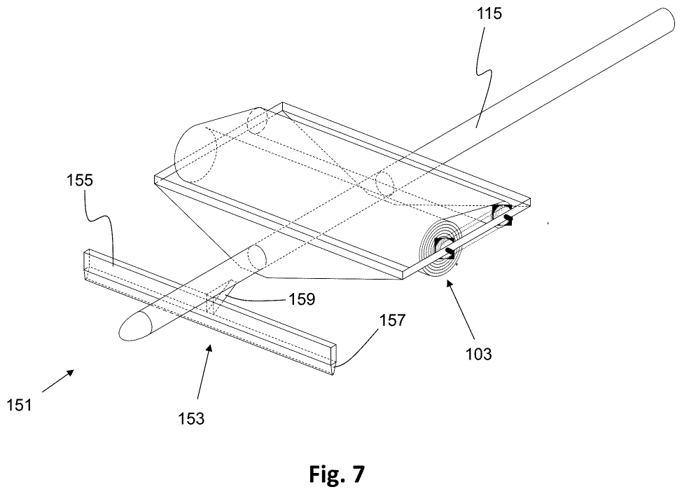

A squeegee assembly 153 is shown as an additional feature of the appliance 151 of FIG. 7. The squeegee assembly comprising a flexible surface contact 157 and the support structure 155 is attached to the underside of the handle 115 by bracket 159. With this geometry, the appliance can be rotated for use of either the roller dispenser or the squeegee.

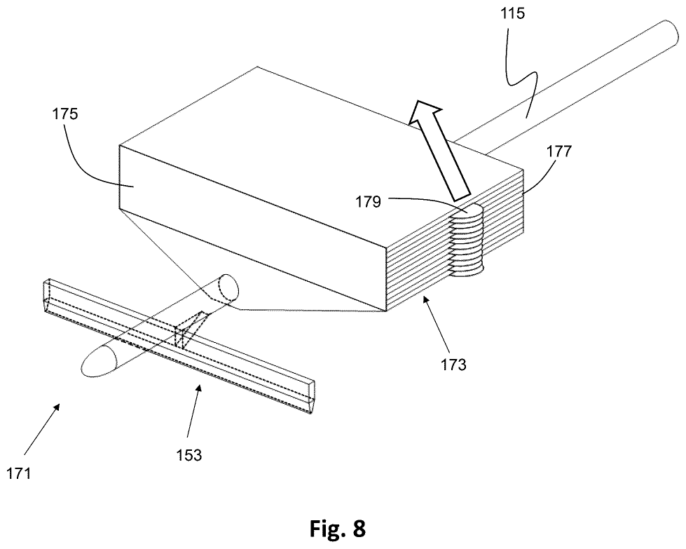

A container 175 of removable wipes 177 is depicted in FIG. 8. The wipes 177 can have a water impermeable backing and are adhered around their perimeters to adjacent wipes by a waterproof adhesive barrier that permits peeling removal of each wipe layer after use. A tab 179 attached to each layer of wipe can be grasped for manual peeling removal and disposal of a wipe after use.

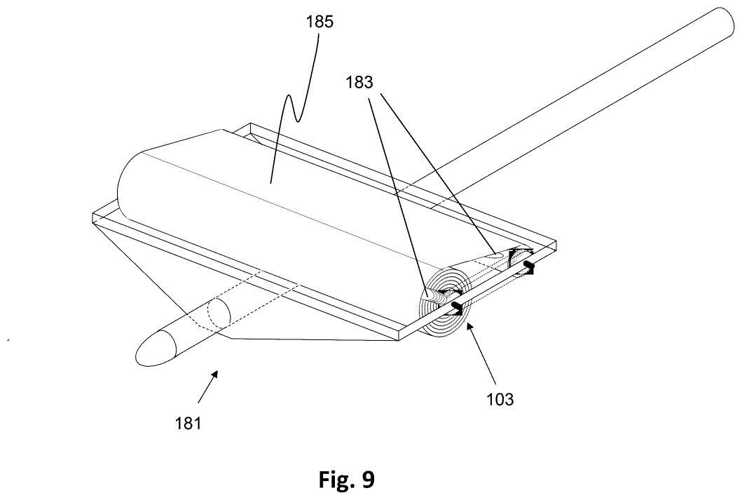

FIG. 9 depicts a roller dispenser 103 but with tear-off wipes 185 after the fashion of FIG. 8. The individual wipes 185 are dispensed from a backer sheet by manually pulling tabs 183.

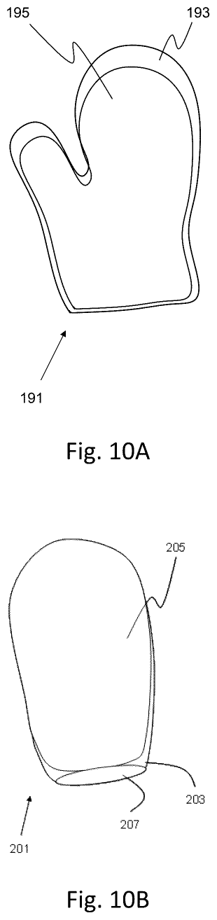

FIG. 10A shows a cleaning mitt that can be either disposable or have a replaceable chemically-impregnated pad. If disposable, the mitt has impregnated material 195 bonded to the mitt glove 193. In the case of reusable mitt glove, a Velcro attachable pad 195 is present. A less formed mitt is shown in FIG. 10B exhibiting a cleaning surface 205 on the body 203 of the mitt 201 having a hand opening 207.

Cleaning wipes can be made from various porous materials, synthetic or natural, that are impregnated with the cleaning composition for insect and debris removal. As mentioned previously, materials such as microfiber fabrics that offer larger surface area contact with the debris-laden surface are preferable.

### Cleaning Wipes and Windshield Wiper Appliance Formulation

The chief difference between a cleaning formulation for wipes (paper or cloth) and a wiper fluid formulation concerns the amount of incorporated solvent or carrier liquid. Since the use of wipes, wiper porous fiber-based appliances, and pad dispensers can be augmented with a water wash, this formulation will likely exhibit a higher concentration of active ingredients than the wiper fluid version. The same types of active ingredients can be used in both formulations. Preferred compounds would include surfactants (ex. quats) and surfactant polymers (ex. polyquats). Solvents would preferably comprise water and/or alcohols. Other candidate ingredients well known in the prior art comprise stabilizing agents, pH buffers, and modifiers of surface tension, interfacial tension and wetting, emulsifying, foaming, and suspension characteristics (Biswas et al., “Influence of additives on the properties of surfactant solutions”, Journal of Applied Chemistry, Volume 10, Issue 2 p. 73-80).

### Windshield Wiper Fluid Formulation

The aforementioned chemicals for insect debris removal can be active ingredients in a wiper fluid that would be dispensed in the same way as conventional windshield wiper fluid. So water soluble and solubilized surfactants are at the head of the list of candidate active ingredients in a windshield wiper formulation. In addition to surfactants, a general prescription for such a cleaner formulation also would comprise a hydrotrope, a builder, and a carrier. Builders are added to upgrade and protect the cleaning efficiency of surfactants. More specifically, builders can act as a buffer, an emulsifier, and to peptize dirt. Hydrotropes keep otherwise incompatible surfactants and builders stable in solution. Finally, the carrier is either water or a solvent.

As mentioned above, polyquaterniums also are viable candidates for few percent concentration solutions useful for insect debris removal. Among these candidate compounds, attention is directed to low toxicity variants that are biodegradable. Wiper fluid formulations that are tailored to insect debris removal can favor aqueous solutions of these compounds. The alternative is to combine these compounds in solutions with conventional windshield wiper fluid. Various cationic surfactants are compatible in solution with methanol, a chief constituent of windshield wiper fluid. Relative concentration of the given surfactant can be adjusted to achieve the requisite debris wetting behavior. In recent years, ester quats have been found advantageous in many commercial and industrial applications due to their biodegradable nature. However, the formulation of esterquat fabric softeners in aqueous based liquid formulations have been challenging because the ester linkages contained in the compound are susceptible to hydrolysis leading to shelf-life instability. Additionally, esterquats function over a narrow pH range. Other quats and quat derivatives have been engineered to overcome these limitations.

Another dispensing concept involves using a cardboard or plastic box or tube to dispense the sleeve as well as provide for its disposal. In this concept, a box containing an opened, full length sleeve is lightly attached at the distal end and perhaps proximal end within the box by such means as adhesive. The sleeve will have an elastic collar near the distal end for capturing the end of the inserted wiper assembly. The dispensing takes place as the box containing the sleeve is lowered down on the wiper assembly so that the sleeve encloses the wiper assembly. As the end of the wiper assembly penetrates the elastic region of the sleeve near the closed end of the box, the sleeve sticks to the wiper assembly so it can be detached from the cardboard box for removal while enclosing the wiper assembly for use. Also present at the closed end of the box, is a cardboard “x-valve”. For disposal, the cardboard box is lowered on the sleeved-wiper assembly so that the end of the sleeve on the wiper assembly penetrates the cardboard x-valve and the entire sleeve is thereby retained in the cardboard box as it is removed.

### Simple Sleeve Approaches

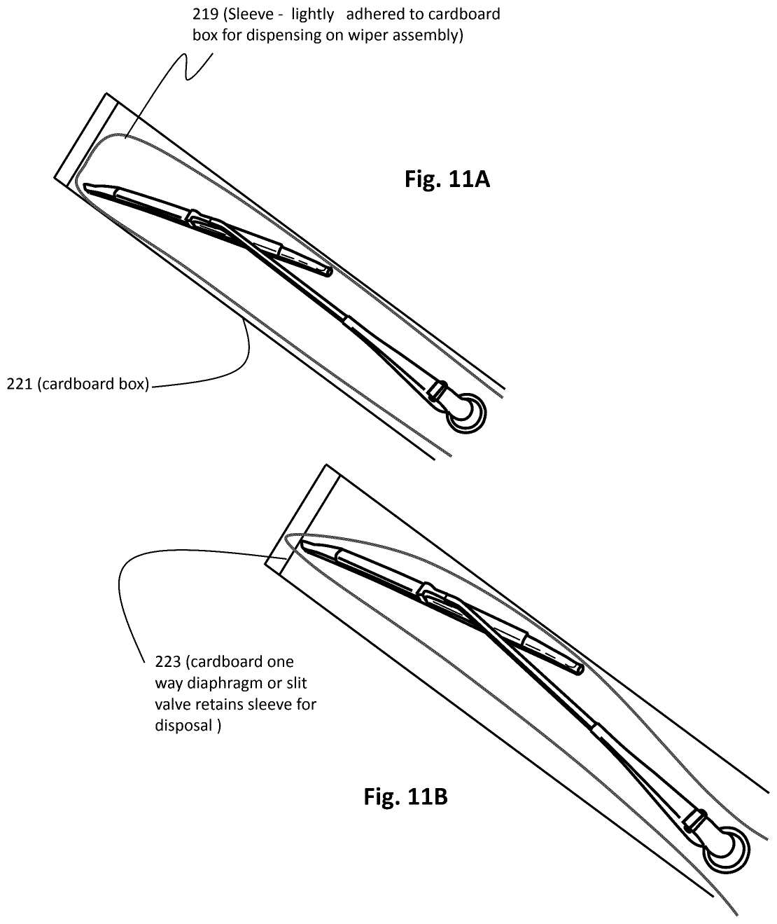

An unfolded sleeve with dispensing and disposal cardboard box is depicted in FIGS. 11A and 11B. Shown in FIG. 11A is the sleeve 219 lightly attached to the interior the cardboard box 221 by adhesive or other means such as biodegradable Velcro, recently introduced to the market. Once the wiper assembly is inserted into the sleeve 219, the sleeve on the wiper assembly is easily removed from the box 221 by withdrawing it. Once the sleeve 219 has been used, the end of the debris laden sleeve is pushed into the cardboard “X” valve 223 at the end of the box. This valve 223 catches the sleeve 219 and retains it inside the box 221 for disposal as the wiper assembly is withdrawn. An alternative to the slotted cardboard is an elastic aperture.

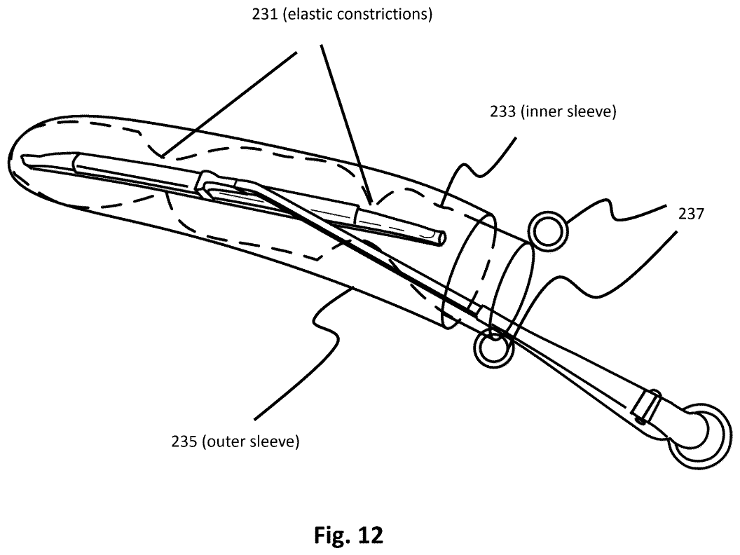

FIG. 12 shows an embodiment of the invention that comprises and inner sleeve 233 and outer sleeve 235. The outer sleeve 235 contains cleaning surfactant formulation and the inner sleeve 233 is designed for folding back over the outer sleeve 235 for clean-hands disposal of the sleeve device. Some elastic constrictions 231 in the inner sleeve 233 can be employed to keep the inner sleeve 233 longitudinally positioned as the sleeve device is removed. Pull rings 237 are shown for ease of device removal but could be replaced by tabs, buttons, strings or other aids.

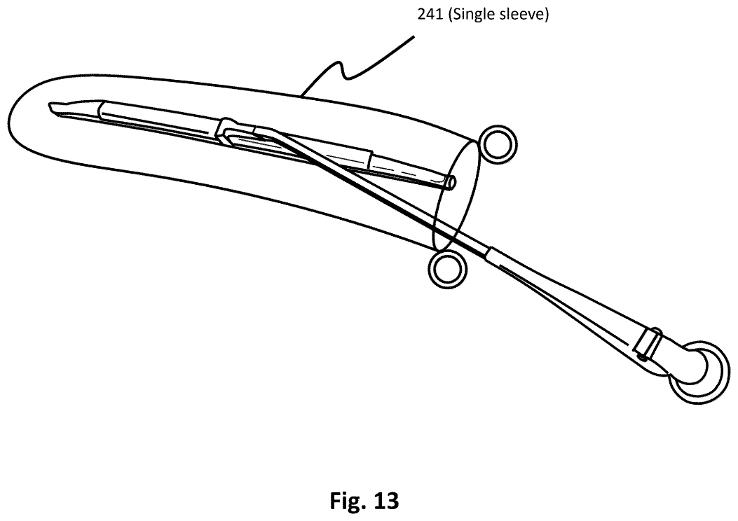

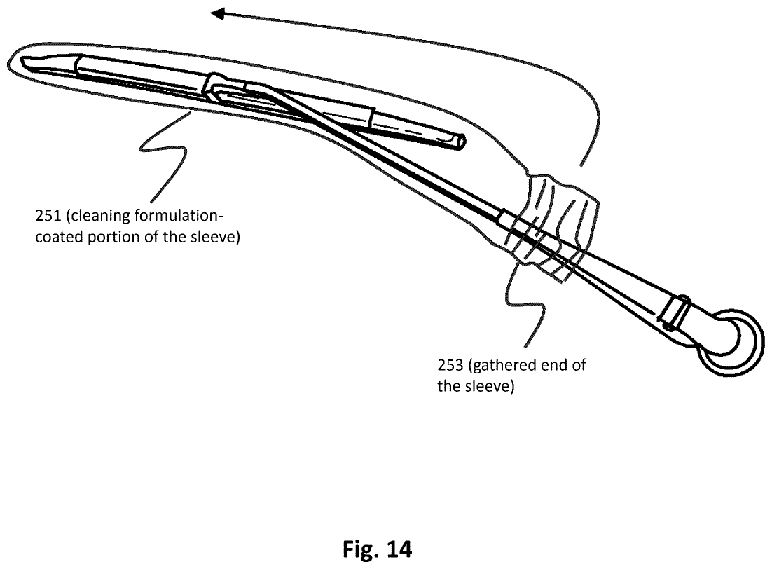

A single sleeve 241 is shown in FIG. 13 and in FIG. 14, the single sleeve 241 is modified to have a larger diameter sleeve portion that is gathered at the open end of the open end of the sleeve in FIG. 14. This gathered portion 253 would be folded back over the balance of the sleeve for its removal. Again, elastic constrictions, not shown, can held retain sleeve placement during removal.

The sleeves of FIGS. 11 through 14 can comprise surfactant formulation coated polymer or surfactant formulation coated or impregnated fabric.

### Sleeve Folding Geometries

With the goal of compact dispensing of the sleeves, various embodiments of the invention invoke folded sleeve geometries. Hence, fold patterns for a collapsible sleeve are considered in the present disclosure and a taxonomy of geometric fold patterns is given below:

### Linear/Translational Folds

Accordion (Zigzag/Pleated): Parallel, evenly spaced folds.
Concertina: Symmetrical inward-outward pleats; collapsible along axis.
Box Pleats: Folds folded under on both sides, producing a box shape.

### Radial/Cylindrical Folds

Bellows Folds: Circumferential folds forming an extendable cylinder.
Yoshimura Pattern: Diamond tessellation causing axial collapse.
Miura-ori (Cylindrical variant): Origami tessellation fold; deploys compactly.
Telescoping Folds: Concentric telescoping rings

### Spiral Folds.

Helical Pleats: Twist around a cylinder; can store rotational tension.
Twist/Furling Folds: Rolled fabric layers; used in sleeves for dynamic motion.

### Polygonal/Origami-Inspired Folds

Waterbomb Tessellation: Can expand or compress in multiple axes.
Eggbox (Cuboctahedral): 3D fold enabling biaxial compression.
Kresling Pattern: Cylindrical folding under torsion.

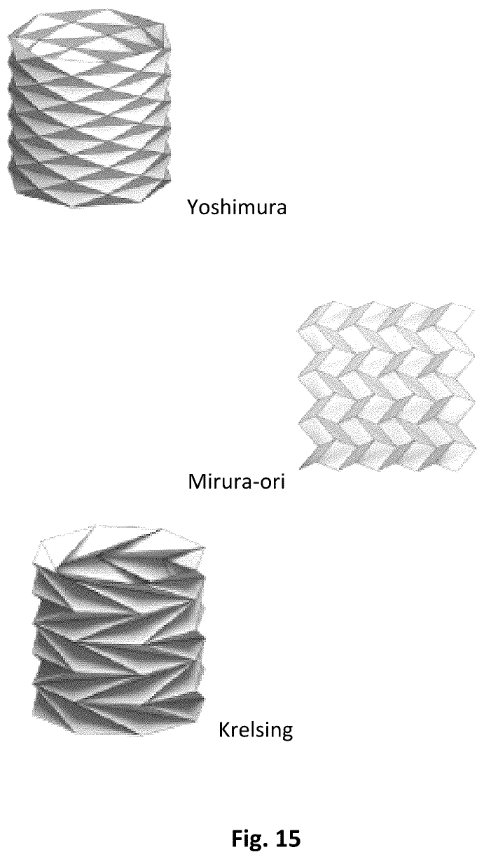

Examples of these fold patterns are shown in FIG. 15.

When considering the sleeve design, a number of characteristics and features should be considered to include support of creasing in a wet or dry state, use of single sleeve that can be folded inside out for removal versus an inner sleeve for surfactant dispensing and an outer sleeve retractable over the inner sleeve for disposal. Various of the fold patterns disclosed above and others can be used singly or in combination for the sleeve design. To achieve good axial compressibility, ease of installation on a wiper blade assembly, and inside out invertibility, the bellows and Yoshimura origami fold patterns are favored. Attention must be paid to retention of fold creases both for installation on the wiper assembly and potentially for removal. Crease retention, either in the dry or wet state of the sleeve will be governed by fabric selection and the nature of surfactant impregnation.

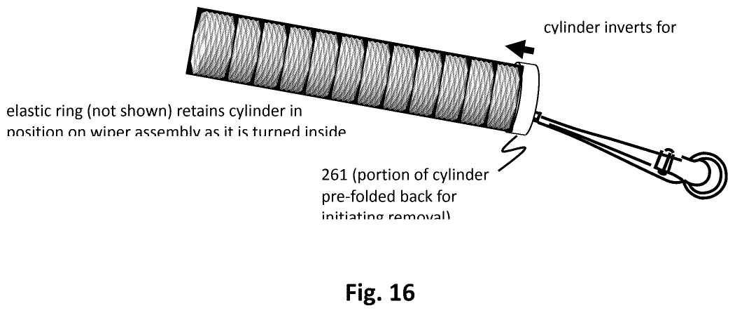

A nested tube geometry is depicted in FIG. 16 in which a smaller diameter origami tube dispenses surfactant and a collapsed larger diameter origami tube can be unfolded to enclose the smaller diameter tube for disposal.

### Favored Geometry for Inversion

A preferred embodiment comprises an invertible single sleeve origami tube as shown in FIG. 16. To facilitate inside-out invertibility, the bellows and Yoshimura fold patterns can be combined, in essence creating a faceted bellows. This is done by replacing smooth circular bellows folds with Yoshimura-patterned facets. Each “ridge” in the bellows is replaced with a zigzag of diamonds or chevrons and yields polygonal bellows that fold more predictably, resist torsion, and facilitate inversion. A portion 261 of the bellows is prefolded to permit ease of inverting the entire tube for removal.

The goals for a Yoshimura bellows sleeve include a) ease of turning inside out in a manner that prevents contamination of hands, b) use of durable flexible fabric that holds creases for folding but resists tearing from repeated use, c) use of either surfactant impregnation or outer surface application of microcapsules. Surfactant impregnation can serve to stiffen the cloth. Such impregnation may occur before or after the cloth sleeve is folded

### Materials and Folding Options

The sleeve can be made from a strong, crease-holding yet flexible textile with some stiffness for fold retention. Examples include nylon or polyester blends with a polyurethane (PU) coating for durability. Alternatively, a biodegradable coated fabric (like PLA or TPU-coated fabric) if eco-friendliness is important. The base fabric can be cotton muslin, linen, or hemp (all absorbent and biodegradable).

Biodegradable stiffening can be achieved with a) starch-based sizing (cornstarch, rice starch, arrowroot) that is sprayed or soaked and iron-dried to stiffen, b) gelatin or agarose spray, c) shellac or beeswax emulsion sprayed on or brushed, d) PVA glue solution (plant derived) brushed on, or e) PLA (corn-based thermoplastic) film or coating that is laminated via heat press. The Yoshimura bellows pattern lines can be strongly pre-creased during manufacturing for consistent folding.

For fold retention, once fabric is treated, it can be folded into the Yoshimura bellows pattern while still slightly damp, or can be re-wet lightly to shape the fabric. It can dry in the folded configuration. As discussed below, biodegradable starch spray of light heat can help set creases.

### Machine Folding

The folding process can be accomplished by first creating the Yoshimura/bellows pattern using CAD software to design the unwrapped 2D Yoshimura tessellation, denoting valley and mountain folds by scores lines-solid lines for cut-through edges and dotted or dashed lines for crease guides. A fabric cutter or plotter with scoring tools (or low-power laser) is used to lightly mark fold lines without cutting through the fabric.

A robotic creasing arm (e.g., a custom end-effector or creasing wheel on a CNC plotter) follows the fold pattern to apply pressure along valley and mountain folds and flex the stiffened fabric just enough to take shape. If using heat-sensitive fabrics, this step can include local heating along fold lines (e.g., with a heated tip or heat gun) and then pressing material into place using a folding press with angular stops.

To form the cylinder for the sleeve, the pre-creased flat sheet is aligned onto a cylindrical jig. The jig can be 3D-printed or laser-cut with slots to guide folds. Optionally use vacuum forming or magnetic clamps to hold edges. A programmable mechanical folding rig, or manual jig-based folding, is used to collapse the folds sequentially, wrapping the fabric into a cylinder and connect the lateral edges (e.g., Velcro, snap buttons, stitching, or welding).

To set creases permanently, depending on the material, heat-setting can be accomplished with oven or air gun. If laminated with thermoplastics, the fabric can cool while constrained to lock in folds. For non-thermoplastic stiffeners, fabric glue or resin can be applied to interior fold lines.

Other options exist for automated folding system design well known in the prior art

### Impregnation and Coating Options

Various methods of deposition of surfactant formulation in the fabric wiper sleeve are feasible. These include a) soaking in which the fabric is dipped in surfactant formulation liquid for absorption, b) coating of the fabric by spraying or brushing a surfactant-containing polymer or hydrogel coating onto the fabric, c) microencapsulation in which surfactant microcapsules are embedded into the fabric which release the surfactant upon pressure triggering, and d) incorporation of surfactant formulation into fabric fibers wherein fibers or yarns are surfactant loaded upon fabric manufacture.

In the case of microcapsule coating, the microcapsule would be applied only to the outside surface of the wiper assembly sleeve which wipes the glass. Interfacial polymerization microcapsules (polyurethane or urea-formaldehyde shells) containing the liquid surfactant can be used and bound to the fabric using a flexible polymer binder (e.g., aqueous polyurethane dispersion). The binder must be elastic and durable to allow folding/unfolding without cracking or shedding capsules. Either the capsules must be robust enough to survive folding but rupture under wiping pressure or fold creases are positioned mostly on uncoated fabric or on the inner surface. Thinner shell walls can be employed so capsules rupture easily during wiping friction/pressure. Capsules will likely break during inversion/removal, but that is inconsequential since at that point, the sleeve will be disposed.

As stated, the shell can be a thin polyurethane or urea-formaldehyde design 1 to 3 microns thick. Interfacial polymerization is ideal for uniform shells and scalable manufacturing. A typical capsule size and might be 10 to 30 microns in diameter as a good balance of durability and rupture sensitivity. The contained surfactant formulation solution can be mixed with glycerol or PEG to tune viscosity.

### Encapsulation Method Suited to Pressure-Triggered Release

For cloth applications, physical-shelled microcapsules that release contents under mechanical stress can be considered. Suitable techniques include those in the table below. Coacervation is a process where macromolecules in a solution separate into two liquid phases: a dense, macromolecule-rich phase (coacervate) and a dilute phase. This occurs when the molecules, often polymers or proteins, undergo liquid-liquid phase separation due to changes in the surrounding environment, such as pH, ionic strength, or temperature. Coacervation is used in various applications, including microencapsulation, drug delivery, and the study of biomolecular condensates.

| | | | Spray-Drying with |
|---|---|---|---|
| | | | Pressure-Sensitive |
| | Interfacial Polymerization | Coacervation | Polymers |
| Core | Liquid surfactant. | Surfactant | Emulsified |
| | | | surfactant |
| Shell | Urea-formaldehyde, | Gelatin-gum arabic or | Spray-Drying with |
| | polyurethane, or polyamide | chitosan-alginate | Pressure-Sensitive |
| | | complex | Polymers |
| Trigger | Shell ruptures under applied | Moderate mechanical | Pressure-softened |
| | pressure (e.g., squeezing or | pressure (adjustable by | polymer like |
| | rubbing). | drying and crosslinking). | modified cellulose |
| | | | or acrylates |
| Characteristics | The monomers react at the | Biodegradable | May require |
| | oil-water interface around | | formulation |
| | the surfactant droplets, | | additives for better |
| | forming a solid shell. | | shelf stability |

Methods for integration of the encapsulant into cloth include a) a pad-dry-cure method in which the cloth is soaked in a suspension of the microcapsules, passed through rollers to remove excess, and heated to fix the capsules (curing may involve binder polymers), b) printing or coating using a screen or rotary printing with a binder matrix and applying localized microcapsules to zones (e.g. Regions away from creases), or c) electrospinning or lamination incorporating capsules in nanofiber mats or between fabric plies.

Tailoring the mechanical rupture sensitivity will involve adjusting one or more parameters. For example, thinner shell thickness would be more sensitive, softer shell material would permit easier rupture, a lower degree of crosslinking would be more deformable, smaller particle size would be more robust, but might release less, and surface localization in the fabric would promote a more responsive release. For biodegradability the shell can comprise Chitosan, cellulose acetate, or starch derivatives. Some references for this technology include: “Microencapsulation of functional textiles”, Carosio et al., Journal of Industrial Textiles, 2020, “Mechanical rupture of polymeric microcapsules for controlled release”, Hu et al., ACS Applied Materials & Interfaces, 2015, and “Encapsulation and controlled release of surfactants”, Gupta & Schreiber, Colloids and Surfaces A, 2006.

The coating should be relatively thin and flexible, so it does not impair wiper function. Encapsulation helps prevent premature surfactant loss during storage or rain exposure. The mechanical action of wiping causes rupture of microcapsules, releasing surfactant exactly where needed. Capsules also protect surfactant from UV degradation and evaporation. The binder should be water-resistant but breathable for durability.

Favored Surfactants for this Embodiment

The best surfactants for the folded sleeve comprise biodegradable cationic or amphoteric quat-like surfactants with detergency. Among several options that combine cleaning power with biodegradability are:

Amidoamine-based Quats-derived from fatty acids and amines-biodegradable and moderately to strongly detergent.
Example: Behenamidopropyl dimethylamine
Properties:
   Derived from behenic acid (plant-based)
   Often neutralized to a cationic form at low pH
   Good cleaning and excellent mildness
   Biodegradable and low toxicity
Used in personal care, antimicrobial formulations, and fabric treatments

Alkyl Polyglucoside Quat Hybrids (Nonionic-Cationic Blends)—These are blends or copolymers of quats with alkyl polyglucosides (APGs).
Biodegradability: High (due to the sugar-based APG component)
Detergency: High (APG contribution)
Cationic activity: Retained from quat moiety

### Dialkyl Esterquats (Improved Esterquats)

A subclass of esterquats with short-chain ester linkages that hydrolyze rapidly.
Example: Distearoylethyl dimonium chloride
Better cleaning than standard esterquats, especially when formulated with nonionics.
OECD-ready biodegrada

Gemini Surfactants (Cationic)—are two-headed, two-tailed quats with a biodegradable spacer.
Can be synthesized with ester or amide linkers that biodegrade.
Some are custom-designed for detergent action+biodegradability.
Not always commercially available off-the-shelf but used in green formulations.
   Rigid Handle and Telescoping Handle with Detachable Pad

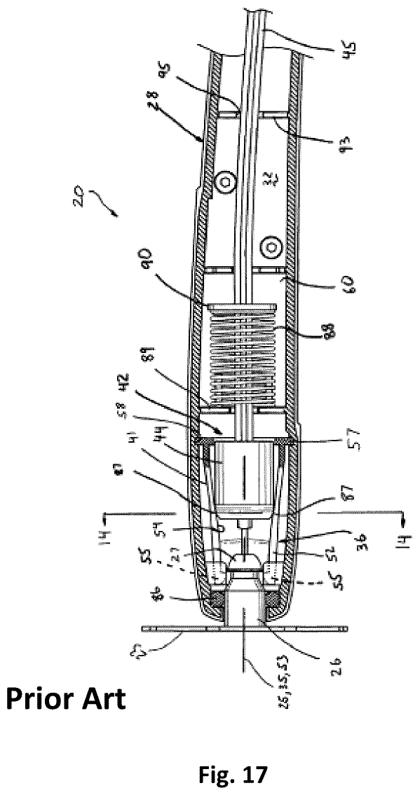

Yet another embodiment of the invention is similar to the Clorox ToiletWand, but with distinctive modifications that address the windshield cleaning task. The ToiletWand is a disposable toilet cleaning system designed to replace traditional toilet brushes. It features a handle that securely attaches to preloaded, disposable cleaning heads, allowing users to clean and disinfect toilet bowls without direct contact with the cleaning surface. After use, the cleaning head can be ejected and disposed of by push button, promoting hygiene and convenience. U.S. Pat. No. 7,386,910, incorporated herein by reference, discloses the details of the system. The handle is pushed straight down onto a disposable cleaning head until it clicks into place and when cleaning is done, a button is slid forward to release the head as per the discussion of FIGS. 5A and 5B in prior art U.S. Pat. No. 7,386,910 and FIG. 17 of the present application. A simplified implementation of the present embodiment with a detachable pad comprises the mechanism of U.S. Pat. No. 7,386,910 with an elongated, more robust rigid handle and a detachable pad that includes surfactant formulation impregnation whether microencapsulated or un-encapsulated.

To employ this concept in a more compact form for windshield cleaning requires a) creating a telescoping handle that, in at least one embodiment, can be button actuated like a folding umbrella but sturdy enough to apply adequate cleaning force to the windshield and sufficient pressure in the case of pressure sensitive microencapsulated surfactant formulations, b) releasably retaining the cleaning head with freedom for pivoting motion exploiting a release button feature, and c) impregnating disposable cleaning pads with surfactant formulation, preferably microencapsulated, for insect and dirt debris removal from the windshield. The telescoping handle permits ease of stowage in a motor vehicle, such as in a door side pocket. The handle may or may or may not be spring loaded. Non-spring-loaded extension poles can be used similar to the Ettore REACH Pole. The hands-free attachment and detachment of the cleaning pad avoids debris and dirt contact with the user. The surfactant impregnation insures easy removal of even dried insects from the windshield.

To span the entire windshield while cleaning, if standing in front of or on one side of a vehicle, would require an extended handle length of about 5 feet, or more. Alternatively, extension of a few feet is adequate to access the windshield by sequentially standing on both sides of a vehicle. A wide range of geometries for the cleaning pad are considered within the scope of the present invention to include rectangular, circular, elliptical, and other shapes, with dimensions spanning several inches to a few feet in the case of an elongated pad. Either spring-loaded or non-spring loaded telescoping handles can be made of aluminum, high strength polymer, or carbon fiber, or other metal or non-metal materials. The push button actuation and spring mechanism for extension are well known in the prior art, especially for telescoping handle umbrellas and such prior art is relied upon herein. In order to have push button-based retention and release of the cleaning pad, in the case of a telescoping handle design, spring tension can be employed here as well.

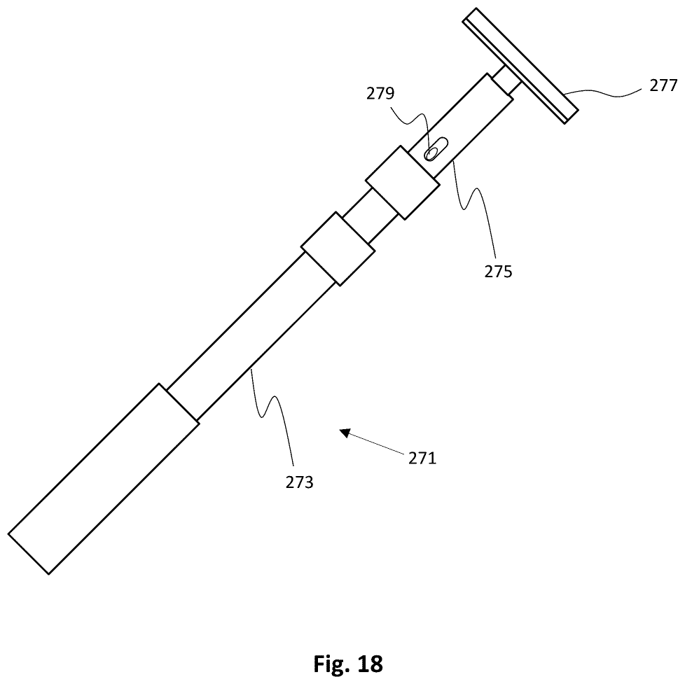

The basic concept for this embodiment derives from U.S. Pat. No. 7,386,910. In FIG. 18 is shown the device 271 that employs a spring-loaded telescoping handle with a plurality of sections with the distal end 275 of the handle removably attached to the cleaning pad 277. As shown in FIG. 18, the handle is gripped beyond proximal section 273 and distal section 275 employs a slide button mechanism 279 for pad retention and release as disclosed in U.S. Pat. No. 7,386,910. The sections of the telescoping handle employ a spring mechanism for automatic handle extension that does not interfere with the distal end section of the handle.

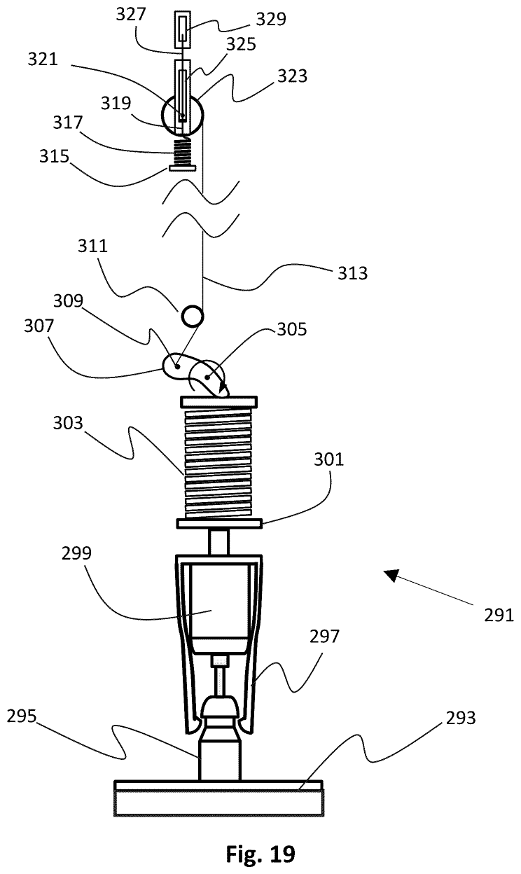

FIG. 19 depicts the collet 297 that holds the pad knob or protrusion 295 in the static condition. To spread the collet 297 for release of the pad knob or protrusion 295 (and hence the pad), an axial force must be applied to the collet spreading cylinder 299 thereby compressing bias spring 303 as per U.S. Pat. No. 7,386,910. An alternative implementation of this embodiment which avoids need for a rigid connection between a user slide button 329 and the collet spreading cylinder 299 permits a user button 329 at the proximal end of the handle. Actuation is achieved by filament 313 traversal along guide pin 311 and attachment at the distal filament end 309 to a lever mechanism 307 with pivot point 305 that upon compression of bias spring 303 against piston plate 301 transfers force to the collet spreading cylinder 299 when adequate tension is applied to the filament 313. The filament 313 is attached at its proximal end to a small spring loaded filament windup reel 323 with the associated filament 313 (or line) made of a strong material that does not substantially elongate under tension, for example Kevlar. The reel 323 keeps the filament connection to the actuator lever 307 under sufficient tension to avoid filament slackness throughout extension or collapse of the telescoping handle, but does not convey enough force to actuate motion of collet 297. The reel 323 would be completely unwound when the handle was fully extended or, if not completely unwound, it could be rotationally-locked with a ratchet/clutch mechanism (not shown). The shaft 321 of the reel 323 is mounted in slide rails 325 so that user depression of slide switch 329 will translate the reel by way of connect 327 and thereby transmit force to the achieve collet 297 actuation and pad 293 release. Spring 317 by way of connection 319 to reel shaft 321 provides a slide switch preload using preload plate 315. Slide switch force can be multiplied by a number of methods well known in the prior art to include a cam with cam follower, a sliding wedge, or lever and linkage means. Detent can be provided in the guide rails 325. The filament 313 can be guided from the reel 323 along the longitudinal axis of the handle and to lever 307 by means of a tube analogous to cable tubing used for bicycle calipers. In a preferred implementation, the pad 293 comprises material impregnated with pressure releasable encapsulants and has a sturdy backer to permit adequate force application to the windshield for surfactant release and debris removal. Pad 293 with backer and pad knob or protrusion 295 can be made of biodegradable materials. The pad 293 can be made of biodegradable fabric or fiber materials previously mentioned. The pad backer and pad knob or protrusion 295 need to have rigidity, so candidate materials include: a) cellulose acetate, coated or uncoated with a hydrophobic material, b) polyhydroxyalkanoates, the family of biodegradable polyesters, and c) polybutylene succinate. Filler materials can be added for additional structural robustness.

A candidate streak free formulation for this embodiment of the invention is use of capsules 10 to 30 microns in diameter containing in the core, 0.3% esterquat and a little alkyl polyglucosides (APGs) solution. The shell can be gelatin-gum Arabic. The APG solution would comprise a) 5 to 10% ethanol or isopropyl alcohol, b) 0.15% decyl glucoside, c) 0.05% corrosion inhibitor (e.g. sodium citrate), d) preservative (biobased) as needed, e) microcapsule slurry to deliver \hat{˜}0.03 to 0.05% esterquat active equivalent, and f) 1 liter of deionized water. This will stay streak free as the quat is mostly kept off the glass until pressure is applied with scrubbing and the alcohol will rinse and flash the small amount of quat released.

A final embodiment of the invention for insect removal from windshields comprises removable or replaceable film-based systems similar to those used for motocross goggles that comprise a multilayer peelable film system. In this multilayer film method, these appliques are called “tear-offs”. Most motocross goggles have two small posts (one on each side of the lens, near the frame). Tear-offs are thin, transparent plastic films with punched holes that fit over these posts. Riders can stack several tear-offs (usually 7-21, depending on the goggle and race rules). Each sheet has a small tab that extends outward, so it can be grabbed quickly while riding. Before a race, a rider (or mechanic) aligns the holes in the tear-offs with the posts on the goggles and stacks them neatly. Sometimes a little moisture is used between layers to reduce static cling and help them peel off smoothly. Alternatively, there is a transparent adhesive between lamination layers of film.

The challenges in application of the tear-off concept to windshields include a) avoidance of wind delamination and unintended peeling of film layers while driving, b) addressing the manual force required to remove films from the windshield, and c) hygienic disposal of debris ridden film.

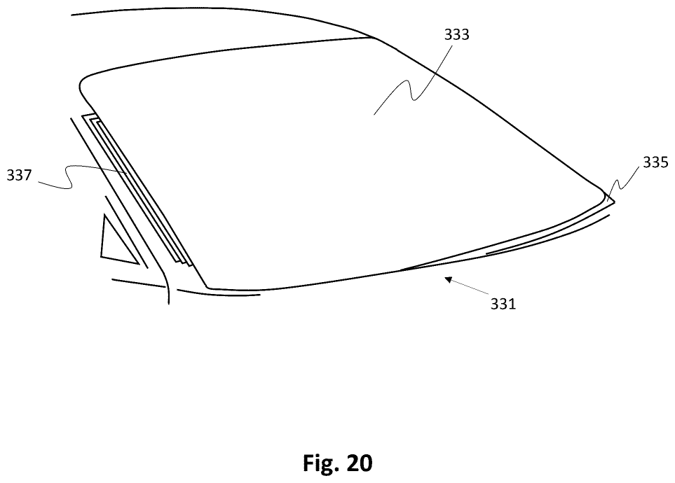

Wind flow direction will be dominated by the vehicle slipstream with air flowing over the vehicle hood and upward along the windshield. With reference to FIG. 20 depicting a vehicle windshield 331, the film layers 335 can be secured below the hood level along the lateral length of the windshield at its base with a self-adhesive strip 333. The clear adhesive used on motocross goggles tear-offs can be used to adhere the film to the windshield and to bind layers; this usually implies a silicone-based or acrylic-based pressure sensitive adhesive (PSAs). Silicone-based PSAs are widely used for clear, removable applications because they stick lightly but don't leave residue. Typically polydimethylsiloxane (PDMS) polymers, often functionalized at chain ends for crosslinking are employed. Acrylic PSAs are also common, particularly for inexpensive or disposable applications like tear-offs. These are made from polyacrylate or polymethacrylate polymers, usually a copolymer of 2-ethylhexyl acrylate and methyl acrylate or similar polymers. The multi-layer film can be rolled onto the windshield laterally, thereby avoiding captivated air bubbles and ensuring good adhesive compliance with the windshield. Staggered tabs 337, each attached to a respective layer of film can be used for gripping to remove the given film layer.

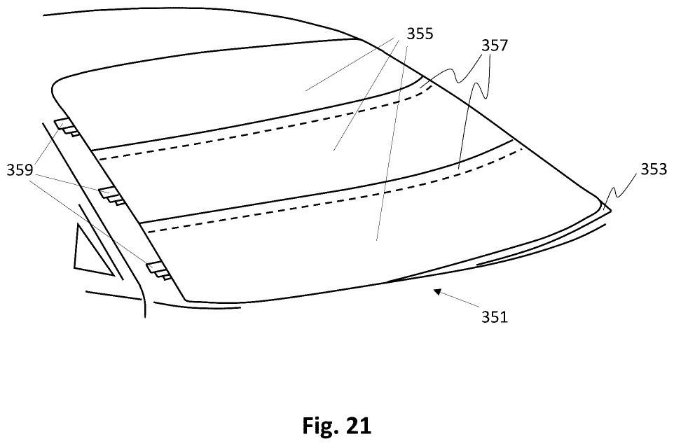

Because polymer sheets the size of a full windshield could require as much as ten pounds of force in order to remove individual layers, the area of a given layer of film may be divided for sequential removal, so only a few pounds of force are necessary. Such segmentation need not induce significant refractive distortions to viewing by the driver. This can be facilitated by small area overlap of segments. Lateral segmentation may create vulnerability to wind-driven delamination. The alternative is depicted in FIG. 21 showing windshield 351 covered with overlapping horizontal film segments 355 of three or more, starting from the top of the windshield and proceeding down to the base of the windshield. This overlap geometry is preferred to avoid vehicle slip stream-driven delamination of the film segments. The overlap areas 357, of width about an inch or so, are sufficient to bind overlapping segments 355 to each other. Each horizontal segment can comprise multiple layers which can be manufactured accordingly for ease of user application to the windshield. For disposal, the films can be peeled off by using a small gripper tool to grasp a film-attached tab 359 at one side of the windshield and walking the film off and dropping it in a waste container.

Various other embodiments of the disclosed concept not delineated, but which derive from this disclosure are deemed within the scope of the present invention.

What is claimed is:

1. A windshield cleaning appliance comprising:
a) a sleeve exhibiting an inner and outer surface that is capable of enclosing a windshield wiper assembly, and
b) a surfactant formulation that is deposited by the sleeve on a vehicle windshield for debris removal from the windshield when the windshield wiper assembly is in motion.

2. A windshield cleaning appliance as recited in claim 1, wherein the sleeve is composed of polymeric material and the surfactant coats the outer surface of the sleeve.

3. A windshield cleaning appliance as recited in claim 1, wherein the sleeve is composed of a fabric material and the surfactant is impregnated into the fabric.

4. A windshield cleaning appliance as recited in claim 1, wherein the sleeve exhibits at least one restriction to hold the sleeve on the wiper and a gathered excess region around the base of the windshield wiper assembly, this gathered excess region capable of being folded back over the sleeve, inverting it as it is removed from the windshield wiper assembly.

5. A windshield cleaning appliance as recited in claim 3, wherein the surfactant formulation is microencapsulated and is impregnated into the fabric and subject to pressure-based release.

6. A windshield cleaning appliance as recited in claim 3, the sleeve is folded for dispensing after the fashion of a method taken from the group of geometric fold patterns comprising:
a) linear/translational folds,
b) radial/cylindrical folds,
c) spiral folds, and
d) polygonal/origami-inspired folds.

7. A windshield cleaning appliance as recited in claim 6, wherein an unfolded sleeve is invertible and capable of being folded back over itself for removal from the windshield wiper assembly.

8. A windshield cleaning appliance comprising:
a) a disposable cleaning implement having a cleaning pad removably mounted to an attachment device,
b) a cleaning pad impregnated with microencapsulated surfactant formulation and exhibiting a backer and an attachment protrusion,
c) an elongated handle,
d) a gripping mechanism coupled to the handle and configured to releasably grip the pad attachment protrusion,
e) a mechanism for releasing the pad attachment from the gripping mechanism,
f) a bias spring that is compressed upon release of the pad attachment protrusion,
g) a user activated button on the handle, and
h) a rigid linkage capable of transferring force from the button to the gripping mechanism for release of the pad attachment protrusion.

9. A windshield cleaning appliance as recited in claim 8 wherein the handle comprises:
a) an elongated telescoping handle exhibiting a plurality of telescoping sections with a distal section attachable to the attachment protrusion and a proximal section for holding by a user,
b) a gripping mechanism coupled to the distal section of the telescoping handle and configured to releasably grip the pad attachment protrusion,
c) a mechanism for releasing the pad attachment from the gripping mechanism on the distal section of the handle,
d) a bias spring that is compressed upon release of the pad attachment protrusion,
e) a user activated button on the distal section of the handle.
f) a rigid linkage mechanism capable of transferring force from the button to the gripping mechanism for release of the pad attachment protrusion,
the proximal rigid linkage mechanism attached to the button, the distal end of the rigid linkage attached to spring biased gripping mechanism and capable of applying actuating force to the gripping mechanism upon push of the button.

10. A windshield cleaning appliance as recited in claim 8 wherein the handle comprises:
a) an elongated telescoping handle exhibiting a distal end near the cleaning pad and a proximal end near a user's grasping position,
b) a gripping mechanism coupled to the handle and configured to releasably grip the pad attachment protrusion,
c) a mechanism for releasing the pad attachment from the gripping mechanism,
d) a bias spring that is compressed upon release of the pad attachment protrusion,
e) a user activated button on the proximal end of the handle, and
f) a filament linkage mechanism capable of transferring force from the button to the gripping mechanism for release of the pad attachment protrusion further comprising:
i) a filament,
ii) a spring-loaded filament reel exhibiting a reel shaft,
iii) a spring attachment to the reel shaft,
iv) a slide track for the filament, and
v) a lever attached to the gripping mechanism.
the proximal end of the filament attached to the spring loaded filament reel, the distal end of the filament attached to the lever, the lever capable of applying actuating force to the gripping mechanism, the spring-loaded filament reel maintaining adequate filament tension to avoid slack throughout extension of collapse of the telescoping handle, but supplying insufficient force via the lever attachment to actuate gripping mechanism release of the pad attachment protrusion, the spring-loaded filament reel shaft spring loaded as a bias against its translation of its shaft in the slide track when translated by user push of the button.

11. A windshield cleaning appliance comprising:
a) a collection of disposable layers of polymeric film applied to the windshield,
b) attachment means along one edge of the collection of layers for attachment to the base of a windshield, and
c) tabs at the lateral side of the collection of layers, each associated with a separate removable layer.

12. A windshield cleaning appliance as recited in claim 11 wherein the polymeric film layers have a transparent pressure sensitive adhesive.

13. A windshield cleaning appliance as recited in claim 11 wherein the polymeric film layers are each divided into a plurality of horizontal pieces that overlap in the vertical direction along a windshield.

14. A method of cleaning a windshield comprising the steps:
a) manufacturing a substrate material taken from the group comprising i) polymer, II) fabric and iii) fiber,
b) forming the substrate into a geometry,
c) applying to the substrate a microencapsulated surfactant formulation, and
d) providing provision for wiping the impregnated substrate on the windshield to remove debris,

15. A method of providing a windshield cleaning appliance as recited in claim 14, wherein step c further comprises coating the substrate with microencapsulated surfactant formulation.

16. A method of providing a windshield cleaning appliance as recited in claim 14, wherein step c further comprises impregnating the substrate with microencapsulated surfactant formulation.

17. A method of providing a windshield cleaning appliance as recited in claim 16, wherein step d further comprises providing removable attachment of the substrate to a handle.

18. A method of providing a windshield cleaning appliance as recited in claim 14, wherein step b further comprises forming the substrate into a sleeve capable of enveloping a windshield wiper assembly and step d further comprises applying the sleeve to a windshield wiper assembly.
